(19) United States
(12) Patent Application Publication
(10) Pub. No.: US 2026/0030187 A1
(43) Pub. Date: Jan. 29, 2026

(54) APPARATUS AND METHOD FOR PROCESSING INPUT/OUTPUT COMPLETION OF STORAGE DEVICE

(71) Applicant: Kookmin University Industry Academy Cooperation Foundation, Seoul (KR)

(72) Inventor: Yongsoo JOO, Seoul (KR)

(73) Assignee: Kookmin University Industry Academy Cooperation Foundation, Seoul (KR)

(21) Appl. No.: 19/233,482

(22) Filed: Jun. 10, 2025

(30) Foreign Application Priority Data
Jul. 24, 2024 (KR) 10-2024-0098049

(51) Int. Cl. G06F 13/20

(52) U.S. Cl. CPC G06F 13/20; G06F 2213/24

(57) ABSTRACT

The present disclosure relates to an apparatus and a method for processing input/output completion of a storage device. The apparatus includes: an input/output command generation unit that generates an input/output command for the storage device: an input/output completion checking method determination unit that provides an input/output request to the storage device based on the input/output command and determines an input/output completion checking method for the storage device; and an input/output completion determination unit that performs an input/output checking procedure according to the input/output completion checking method and determines whether the input/output command is completed. Therefore, the present disclosure may dynamically switch to the most advantageous technique for detecting I/O completion of the storage device, depending on CPU contention arising from CPU sharing of an I/O request process, and may improve I/O performance by quickly detecting the I/O completion of the storage device.

### CROSS-REFERENCE TO RELATED APPLICATION

This application claims the benefit of and priority to Korean Patent Application No. 10-2024-0098049, filed on Jul. 24, 2024, the entire disclosure(s) of which is hereby incorporated herein by reference in its entirety.

### BACKGROUND

### Field

The present disclosure relates to a technology for input/output completion of a storage device, and more specifically, relates to an apparatus and a method for processing input/output completion of a storage device, which can quickly detect a completion time of an input/output in a storage device of a computer system.

### Description of Related Art

Three methods of interrupt, polling, and hybrid polling may be used to detect a completion time of an input/output (hereinafter, may be referred to as an I/O) in a storage device of a computer system.

FIG. 1 is a view illustrating an I/O completion technique for the storage device.

(a) of FIG. 1 illustrates an interrupt technique. In the interrupt technique, when an I/O request is submitted to the storage device, the I/O request process waits in an idle state and does not use the CPU while waiting for I/O completion. When the I/O is completed, the storage device generates an interrupt so that the I/O request process wakes up. In this process, I/O performance is degraded due to an overhead of context switching and interrupt handler processing. This is a problem especially in recently released low-latency SSDs. The latency of the storage device itself has improved to within tens of microseconds, and thus the interrupt processing overhead becomes relatively prominent.

As an alternative to cope with this performance degradation, the use of polling has started to be proposed.

(b) of FIG. 1 illustrates a polling technique. Polling is a process of repeatedly reading a register value of an I/O completion status of the storage device without context switching after the I/O request is submitted. Therefore, the I/O request process may be immediately resumed without any delay due to context switching and interrupt handler calling at the I/O completion time. However, this process exclusively uses the CPU, thereby causing a problem in that CPU usage rises to 100%. When two or more processes generate I/O requests on one CPU, serious performance degradation occurs.

A hybrid polling technique has been proposed to avoid the disadvantages of interrupt and polling and to achieve the advantages of both, and has been introduced into the Linux kernel 4.10.

(c) to (e) of FIG. 1 illustrate the hybrid polling technique. An operating principle of the hybrid polling is to execute a timer function of an operating system after identifying a recent I/O latency pattern to estimate the I/O completion time, and to prevent unnecessary CPU usage by initiating polling after the process sleeps for the difference from the current time. When the I/O completion time is accurately predicted, the I/O completion may be immediately checked at the polling start time, and the I/O request process may be returned.

When the I/O completion time predicted by the hybrid polling is too early compared to the actual time, undersleeping occurs as in (c) of FIG. 1, which lengthens the polling time and increases CPU usage. On the other hand, when the predicted I/O completion time is too late, oversleeping occurs as in (d) of FIG. 1, which delays the return to the I/O request process by that amount. Therefore, the I/O performance perceived by the I/O request process may be degraded.

An I/O completion time prediction algorithm used in the hybrid polling embedded in Linux is implemented in a simple way in which statistics on the I/O latency are updated in units of 100 ms epochs, and the process sleeps 50% of the average I/O latency value from the previous epoch. This epoch-based sleep duration determination algorithm has a disadvantage in that its accuracy drops when the I/O latency of the storage device changes drastically. In order to improve this disadvantage, methods have been proposed to reduce the epoch to 10 ms or to differentiate the sleep duration to 10-90% of the latency average value depending on the size of the I/O request. However, since all of these methods update the sleep duration through epoch-based sampling, the accuracy in predicting the I/O completion time significantly drops when the I/O latency changes significantly before and after the epoch.

In order to cope with these disadvantages of epoch-based hybrid polling, improved hybrid polling is proposed by the present applicant. Hereinafter, in order to distinguish the improved hybrid polling from existing hybrid polling, the improved hybrid polling will be referred to as “adaptive hybrid polling”. The adaptive hybrid polling introduces a novel I/O latency tracking technique of continuously adjusting the sleep duration for each I/O, based on sleep results for the two most recent I/O requests. Through this technique, the following results are realized: (1) the sleep duration may be compensated for each I/O in a fast and timely manner; (2) a difference between an expected I/O latency and an actual I/O latency may be continuously compensated by using the latest feedback; (3) when the estimated device I/O latency exceeds the actual latency, the sleep duration may be quickly reduced to pursue promptness, accuracy, and safety.

Despite efforts to improve the sleep duration prediction algorithm as described above, all hybrid polling techniques, including adaptive hybrid polling, must invoke the timer function of the operating system for the sleep. As a result, hybrid polling technique has two fundamental limitations as follows.

First, in the process of calling the timer function of the operating system, there are problems not only of delay due to context switching but also of the working set of data being evicted from the cache. The former problem may be hidden by setting the sleep duration to be sufficiently short so that the hybrid polling causes undersleeping as in (c) of FIG. 1. However, performance degradation caused by the latter problem occurs due to a cache miss after the I/O request process is resumed. Therefore, the latter problem cannot be hidden, even when the sleep duration is set to be as short as possible. Accordingly, in a situation where only one I/O request process is executed on one CPU, it is advantageous to select the polling technique instead of the hybrid polling technique. The reason is that the polling technique may avoid the above-described cache miss without suffering from performance degradation due to exclusive usage of the CPU.

Second, when too many I/O request processes share the CPU, the hybrid polling cannot be operated as intended due to severe timer delay, as illustrated in (e) of FIG. 1 resulting in degraded I/O performance. The hybrid polling implements sleep by using the timer function of the operating system, and the actual sleep duration—from the timer function call to the return—is measured to be longer than the requested sleep duration passed as an argument to the timer function. This is because additional time is required for the task scheduler to assign the CPU to the I/O request process after the timer interrupt occurs. The hybrid polling technique is implemented on the assumption that this timer delay—that is, the difference between the actual sleep duration and the requested sleep duration—is sufficiently shorter than the I/O processing time of the storage device. However, when the number of I/O request processes waiting for CPU assignment becomes excessive, the timer delay of the I/O request process also becomes significant. In this case, even if the requested sleep duration of the hybrid polling is sufficiently short, the actual sleep duration may still increase. As a result, by the time the CPU is assigned, the I/O requested to the storage device may have already been completed, causing oversleeping. In such situations, the advantages of hybrid polling are not realized, and additional procedures required for implementing the hybrid polling, such as timer settings, only contribute unnecessary overhead. Consequently, hybrid polling may show lower I/O performance compared to the interrupt-based technique.

Korean Patent Publication No. 10-2023-0096289 (Jun. 30, 2023) is an example in the related art.

### SUMMARY

One embodiment of the present disclosure is to provide an apparatus and a method for processing input/output completion of a storage device, which can improve accuracy in predicting an input/output completion time in a storage device of a computer system, and which can result in lower CPU usage and higher I/O performance when an input/output task of the storage device is performed.

One embodiment of the present disclosure is to provide an apparatus and a method for processing input/output completion of a storage device, which enables the rapid completion of input/output operations of a storage device by selecting the most advantageous technique for I/O performance—whether interrupt, polling, or adaptive hybrid polling—based on CPU contention.

One embodiment of the present disclosure is to provide an apparatus and a method for processing input/output completion of a storage device, which can achieve significant improvement in I/O performance only by improving an operating system function without hardware modification, by dynamically switching among interrupt, polling, and adaptive hybrid polling techniques, which respectively have different advantages and disadvantages depending on the workload.

According to embodiments, there is provided an apparatus for processing input/output completion of a storage device. The apparatus includes an input/output command generation unit that generates an input/output command for the storage device, an input/output completion checking method determination unit that provides an input/output request to the storage device based on the input/output command and determines the input/output completion checking method of the storage device, and an input/output completion determination unit that performs an input/output checking procedure according to the input/output completion checking method and determines whether the input/output command is completed.

The input/output completion checking method determination unit may determine the input/output completion checking method by selecting one from among a polling mode using a polling method, an adaptive hybrid polling mode using an adaptive hybrid polling method, a CPU contention re-evaluation mode using an adaptive hybrid polling method, and an interrupt mode using an interrupt method.

The input/output completion checking method determination unit may set the adaptive hybrid polling mode as the default mode, may calculate CPU contention through the adaptive hybrid polling method, and may select the mode based on the calculated CPU contention.

The input/output completion checking method determination unit may determine the CPU contention based on the number of active sleep timers running on the CPU and whether a timer failure occurs in a process of performing the adaptive hybrid polling method.

The input/output completion checking method determination unit may determine that a timer failure has occurred if the requested sleep duration is reduced to a predefined minimum sleep duration in a process of performing the adaptive hybrid polling method.

When the sleep timer failure does not occur, the input/output completion checking method determination unit may execute a first specific number of input/output commands using the adaptive hybrid polling method, and thereafter, may check the number of active sleep timers to switch to the polling mode or to maintain the adaptive hybrid polling mode.

When the number of active sleep timers identified through checking is “1”, the input/output completion checking method determination unit may determine the polling method as the input/output completion checking method by switching to the polling mode.

The input/output completion checking method determination unit may execute a second specific number of the input/output commands by using the polling method and thereafter may return to the adaptive hybrid polling mode.

When the above sleep timer fails, the input/output completion checking method determination unit may switch to the CPU contention re-evaluation mode, may execute a first specific number of the input/output commands using the adaptive hybrid polling method and thereafter may re-evaluate the input/output completion checking method.

The input/output completion checking method determination unit may check the number of active sleep timers in a process of re-evaluating the input/output completion checking method and may determine whether to return to the adaptive hybrid polling mode, switch to interrupt mode, or maintain the CPU contention re-evaluation mode.

When the number of active sleep timers identified through checking is “1”, the input/output completion checking method determination unit may return to the adaptive hybrid polling mode.

When the number of active sleep timers identified through checking exceeds “1” and does not exceed a first specific reference, the input/output completion checking method determination unit may maintain the CPU contention re-evaluation mode.

When the number of active sleep timers identified through checking exceeds a first specific reference, the input/output completion checking method determination unit may determine the interrupt method as the input/output completion checking method by switching to the interrupt mode.

The input/output completion checking method determination unit may return to the CPU contention re-evaluation mode after executing a third specific number of input/output commands using the interrupt method.

According to embodiments, there is provided a method for processing input/output completion of a storage device. The method includes an input/output command generation step of generating an input/output command for the storage device, an input/output completion checking method determination step of providing an input/output request to the storage device based on the input/output command and determining an input/output completion checking method of the storage device, and an input/output completion determination step of determining whether the input/output command is completed by performing an input/output checking procedure according to the input/output completion checking method.

In the input/output completion checking method determination step, the input/output completion checking method may be determined by selecting one from among a polling mode using a polling method, an adaptive hybrid polling mode using an adaptive hybrid polling method, a CPU contention re-evaluation mode using an adaptive hybrid polling method, and an interrupt mode using an interrupt method.

In the input/output completion checking method determination step, the adaptive hybrid polling mode may be set as the default mode, CPU contention may be calculated through the adaptive hybrid polling method, and the mode may be selected based on the calculated CPU contention.

In the input/output completion checking method determination step, the CPU contention may be determined based on the number of active sleep timers running on the CPU and whether a timer failure occurs in a process of performing the adaptive hybrid polling method.

In the input/output completion checking method determination step, the occurrence of an event in which a requested sleep duration is reduced to a predefined minimum sleep duration in a process of performing the adaptive hybrid polling method may be determined to be a timer failure.

The disclosed technology may have the following advantageous effects. However, it does not mean that a specific embodiment should include all of the following advantageous effects or should include only the following advantageous effects, and thus, the scope of the disclosed technology should not be construed as being limited thereby.

An apparatus and a method for processing input/output completion of a storage device according to one embodiment of the present disclosure may improve accuracy in predicting an input/output completion time in a storage device of a computer system and may result in lower CPU usage and higher I/O performance when an input/output task of the storage device is performed.

An apparatus and a method for processing input/output completion of a storage device according to one embodiment of the present disclosure may quickly perform input/output completion of the storage device by selecting the most advantageous technique for I/O performance—whether interrupt, polling, or adaptive hybrid polling—based on CPU contention.

According to one embodiment of the present disclosure, an apparatus and a method for processing input/output completion of a storage device may achieve significant improvement in I/O performance only by improving an operating system function without hardware modification, by dynamically switching among interrupt, polling, and adaptive hybrid polling techniques, which respectively have different advantages and disadvantages depending on the workload.

### BRIEF DESCRIPTION OF THE DRAWING

FIG. 1 is a view illustrating a technique for I/O completion of a storage device.

FIG. 2 is a view illustrating a system for processing input/output completion according to the present disclosure.

FIG. 3 is a view describing a system configuration of an apparatus for processing input/output completion in FIG. 2.

FIG. 4 is a view describing a functional configuration of the apparatus for processing input/output completion in FIG. 2.

FIG. 5 is a flowchart describing a method for processing input/output completion of a storage device according to the present disclosure.

FIG. 6 is a view describing one embodiment of an operation flow of adaptive hybrid polling according to the present disclosure.

FIG. 7 is a view describing another embodiment of the operation flow of the adaptive hybrid polling according to the present disclosure.

FIG. 8 is a view describing a process of switching an input/output completion checking method of a storage device according to the present disclosure.

FIGS. 9 to 14 are graphs illustrating results of performance analysis experiments according to the present disclosure.

### DETAILED DESCRIPTION

Specific structural or functional descriptions in the embodiments of the present disclosure introduced in this specification or application are only for description of the embodiments of the present disclosure. The descriptions should not be construed as being limited to the embodiments described in the specification or application. The present disclosure may, however, be embodied in many different forms, but should be construed as covering modifications, equivalents or alternatives falling within ideas and technical scopes of the present disclosure. Further, since effects disclosed herein do not mean that a specific embodiment should include all or only the effects, the scope of the present disclosure should not be construed as being limited thereto.

Meanwhile, the meaning of terms described herein will be understood as follows.

It will be understood that, although the terms “first”, “second”, etc. may be used herein to distinguish one element from another element, these elements should not be limited by these terms. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to” or “directly adjacent to” should be construed in the same way.

In the present disclosure, the singular forms are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In each step, reference characters (e.g. a, b, c, etc.) are used for the convenience of description. The reference characters do not designate the order of the steps, and the steps may be performed in a different order unless the context clearly indicates otherwise. That is, the steps may be performed in the specified order, may be performed substantially simultaneously, or may be performed in a reverse order.

The present disclosure can be implemented as a computer-readable code on a computer-readable recording medium. The computer-readable recording medium includes all types of recording devices in which data readable by a computer system is stored. Examples of the computer-readable recording medium include ROM, RAM, CD-ROM, magnetic tape, floppy disk, an optical data storage device, etc. In addition, the computer-readable recording medium may be distributed in a computer system connected via a network, so that computer-readable codes may be stored and executed in a distributed manner.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

The present disclosure proposes a dynamic mode switching technique that may check whether an I/O request is completed by selecting the most advantageous technique for I/O performance—whether interrupt, polling, or adaptive hybrid polling—which are used to detect an I/O completion time in a storage device of a computer system, depending on CPU contention.

According to the present disclosure, adaptive hybrid polling is basically performed, and CPU contention is continuously observed to switch the mode to polling or interrupt so that the selected mode is beneficial for I/O performance. CPU contention may refer to how many I/O request processes share the CPU.

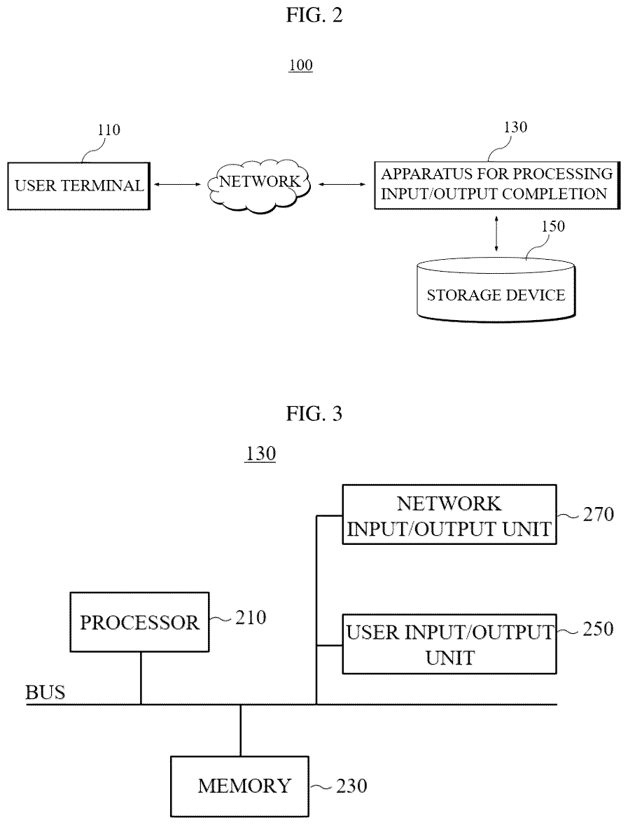

Hereinafter, an apparatus and a method for processing input/output completion of a storage device according to the present disclosure will be described in detail with reference to FIGS. 2 to 13.

FIG. 2 is a view illustrating a system for processing input/output completion according to the present disclosure.

Referring to FIG. 2, the system for processing input/output completion 100 may include a user terminal 110, an apparatus for processing input/output completion 130, and a storage device 150.

The user terminal 110 may correspond to a computing device that may utilize an operation for processing input/output completion of the storage device 150 in conjunction with the apparatus for processing input/output completion 130, and may be implemented as a smart phone, a laptop, or a computer. Without being necessarily limited thereto, the user terminal 110 may also be implemented as various devices such as a tablet PC. The user terminal 110 may be connected to the apparatus for processing input/output completion 130 through a network, and at least one user terminal 110 may be simultaneously connected to the apparatus for processing input/output completion 130. Preferably, the configuration may be implemented inside the user terminal 110. In addition, a dedicated program or application in conjunction with the apparatus for processing input/output completion 130 may be installed and executed in the user terminal 110.

The apparatus for processing input/output completion 130 may be implemented as a computing device or a corresponding server that processes input/output completion of the storage device 150 by applying a dynamic mode switching technique among interrupt, polling, and adaptive hybrid polling according to the present disclosure. For example, the apparatus for processing input/output completion 130 may include a Linux kernel, which is a computer operating system. The apparatus for processing input/output completion 130 may be connected to the user terminal 110 through a network, and may exchange related data. In addition, the apparatus for processing input/output completion 130 may generate at least one input/output command for the storage device 150, may detect whether the input/output of the storage device 150 is completed, and may complete the input/output command. The apparatus for processing input/output completion 130 may switch a current input/output completion checking method to another method that is more advantageous to I/O performance, based on contention of the CPU that processes an input/output request. The input/output completion checking method may include interrupt, polling, and adaptive hybrid polling. The apparatus for processing input/output completion 130 may dynamically switch among the interrupt, the polling, and the adaptive hybrid polling, based on the CPU contention.

The storage device 150 may correspond to various types of memory. The storage device 150 may be implemented as nonvolatile or volatile memory, and may be used to store all data required for executing an application of the user terminal 110. For example, the storage device 150 may correspond to a Solid State Drive (SSD). Here, the storage device 150 processes an input/output request (I/O request).

FIG. 3 is a view for describing a system configuration of the apparatus for processing input/output completion in FIG. 2.

Referring to FIG. 3, the apparatus for processing input/output completion 130 may include a processor 210, a memory 230, a user input/output unit 250, and a network input/output unit 270. In this case, an embodiment of the present disclosure does not have to simultaneously include all of the above-described configurations, and some of the configurations may be omitted depending on each embodiment. Some or all of the above-described configurations may be selectively included and implemented.

The processor 210 may execute a procedure for processing input/output completion of the storage device according to an embodiment of the present disclosure, may manage the memory 230 read or written in this process, and may schedule a synchronization time between a volatile memory and a non-volatile memory in the memory 230. The processor 210 is connected to the storage device 150 to provide an input/output request, and may manage and process the provided input/output request. The processor 210 may control an overall operation of the apparatus for processing input/output completion 130, and may be electrically connected to the memory 230, the user input/output unit 250, and the network input/output unit 270 to control a data flow therebetween. The processor 210 may be implemented as a Central Processing Unit (CPU) of the apparatus for processing input/output completion 130. The processor 210 may check whether the input/output request is completed by using one of an interrupt method, a polling method, and an adaptive hybrid polling method, based on contention of the CPU that performs an input/output request process.

The memory 230 may include an auxiliary memory device implemented as a non-volatile memory such as a Solid State Drive (SSD) or a Hard Disk Drive (HDD) and used to store all data required for the apparatus for processing input/output completion 130, and may include a main memory device implemented as a volatile memory such as a Random Access Memory (RAM). In addition, the memory 230 may be implemented by the electrically connected processor 210 to store a set of commands that execute a method for processing input/output completion of the storage device according to the present disclosure.

The user input/output unit 250 may include an environment for receiving a user input and an environment for outputting specific information to a user. For example, the user input/output unit 250 may include an input device, such as an adapter including a touch pad, a touch screen, a visual keyboard, or a pointing device, and an output device, such as an adapter including a monitor or a touch screen.

The network input/output unit 270 may provide a communication environment for connecting to the user terminal 110 via a network. For example, the network input/output unit 270 may include an adapter for communication, such as a Local Area Network (LAN), a Metropolitan Area Network (MAN), a Wide Area Network (WAN), and a Value Added Network (VAN). In addition, for wireless transmission of data, the network input/output unit 270 may be implemented to provide a short-distance communication function, such as WiFi and Bluetooth, or a wireless communication function of 4G or higher.

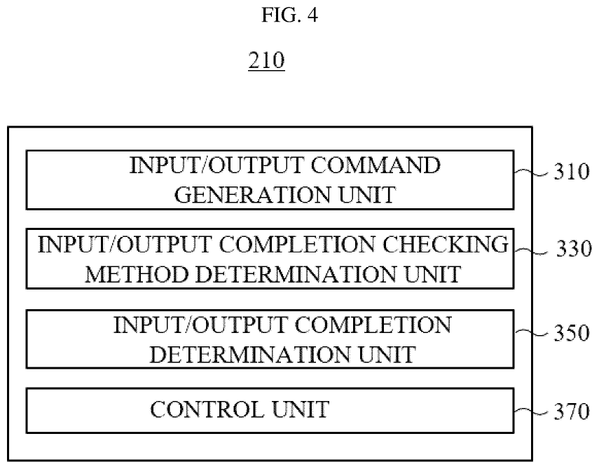

FIG. 4 is a view for describing a functional configuration of the apparatus for processing input/output completion 130 in FIG. 2.

Referring to FIG. 4, the apparatus for processing input/output completion 130 may primarily perform the adaptive hybrid polling method according to the present disclosure, may continuously monitor the CPU contention, may switch to the method most advantageous to the I/O performance among the interrupt method, the polling method, and the adaptive hybrid polling method, and may check whether the input/output request is completed. For this purpose, the apparatus for processing input/output completion 130 may include an input/output command generation unit 310, an input/output completion checking method determination unit 330, an input/output completion determination unit 350, and a control unit 370.

The input/output command generation unit 310 may generate an input/output command for the storage device 150.

The input/output completion checking method determination unit 330 may provide the input/output request to the storage device 150, based on the input/output command, and may determine an input/output completion checking method of the storage device 150. In one embodiment, the input/output completion checking method determination unit 330 may select the input/output completion checking method of the storage device 150 based on the CPU contention. The CPU contention means how many input/output request processes share the CPU. Here, the input/output completion checking method may include the interrupt method, the polling method, and the adaptive hybrid polling method. Each of the input/output completion checking methods may have different I/O performance depending on the CPU contention.

The input/output completion checking method determination unit 330 may calculate the CPU contention through the adaptive hybrid polling method. The input/output completion checking method determination unit 330 may set the adaptive hybrid polling method as the default mode for determining the input/output completion, may continuously observe the contention of the processor 210, and may switch input/output completion determination modes by using the most advantageous method for I/O performance among the polling method, the adaptive hybrid polling method, and the interrupt method. In one embodiment, the input/output completion determination mode may include a polling mode using the polling method, an adaptive hybrid polling mode using the adaptive hybrid polling method, a CPU contention re-evaluation mode using the adaptive hybrid polling method, and an interrupt mode using the interrupt method. Here, the input/output completion checking method determination unit 330 may determine the input/output completion checking method as one of the input/output completion determination modes.

The input/output completion checking method determination unit 330 may determine the CPU contention based on the number of active sleep timers running on the processor 210 and whether a timer failure occurs in a process of performing the adaptive hybrid polling method. Here, the number of active sleep timers corresponds to the number of input/output commands simultaneously executed in each CPU, that is, an input/output queue depth (QD). A sleep timer failure occurs if the timer delay exceeds a predefined threshold value. Specifically, the input/output completion checking method determination unit 330 may evaluate the CPU contention by observing the input/output queue depth (QD) and determining whether a timer failure occurs for the input/output command generated in each CPU. The input/output completion checking method determination unit 330 may initially select the adaptive hybrid polling method as the input/output completion checking method at system startup. The input/output completion checking method determination unit 330 may update a variable value of the input/output queue depth (QD) by adding “1” to the variable of the input/output queue depth (QD) of the corresponding CPU when the timer is called in the process of performing the input/output by using the adaptive hybrid polling method, which is the default mode, and by subtracting “1” from the variable of the input/output queue depth (QD) when the process returns from the timer. In this manner, the input/output completion checking method determination unit 330 may obtain the number of the input/output commands simultaneously executed in each CPU.

In addition, the input/output completion checking method determination unit 330 may determine a sleep timer failure if the timer delay exceeds a predefined threshold value. In order to calculate the timer delay, the input/output completion checking method determination unit 330 needs to acquire and store a timestamp at each time the timer is called and each time the process returns to the input/output request process. In addition, the input/output completion checking method determination unit 330 needs to define a threshold value corresponding to a timer failure, which may vary depending on a combination of the CPU, memory, storage device, and the like which form the system. Therefore, a correction task for determining an appropriate threshold value is required for each system. In one embodiment, the input/output completion checking method determination unit 330 may determine a sleep timer failure based on the requested sleep duration of the adaptive hybrid polling method, instead of the timer delay.

When the adaptive hybrid polling method evaluates a sleep result for each I/O and the result indicates undersleeping, the adaptive hybrid polling method increases the sleep duration; conversely, when the result indicates oversleeping, it decreases the duration. However, when too many processes are waiting for CPU assignment, the adaptive hybrid polling method observes oversleeping caused by timer delays. In this case, the adaptive hybrid polling method fails to recognize the timer delay as the source of the oversleeping and instead mistakenly attributes it to an overly long previously requested sleep duration. As a result, the adaptive hybrid polling method reduces the subsequent requested sleep duration by a prescribed ratio. However, unless the timer delay is alleviated, the oversleeping phenomenon is not improved, and the requested sleep duration exponentially decreases to a predefined minimum sleep duration (D_MIN), for example, 1 μs. Therefore, the input/output completion checking method determination unit 330 may detect a timer failure based on the unique behavior of the adaptive hybrid polling method—specifically, when oversleeping persists regardless of the length of the requested sleep duration in a process of performing the adaptive hybrid polling method. That is, the input/output completion checking method determination unit 330 may determine that a timer failure has occurred if the requested sleep duration is reduced to the predefined minimum sleep duration in the process of performing the adaptive hybrid polling method.

When a sleep timer failure occurs, the input/output completion checking method determination unit 330 may select the CPU contention re-evaluation mode as the input/output completion determination mode, may maintain the adaptive hybrid polling method, may execute a first specific number of the input/output commands, and thereafter may re-evaluate the input/output completion checking method. Here, the input/output completion checking method determination unit 330 may calculate a value of the input/output queue depth (QD) through the number of active sleep timers, and may re-evaluate the input/output completion checking method based on this value. The input/output completion checking method determination unit 330 may determine whether to return to the default mode, switch to the interrupt mode, or maintain the CPU contention re-evaluation mode in a process of re-evaluating the input/output completion checking method. In one embodiment, the input/output completion checking method determination unit 330 may determine that the CPU contention is resolved when the average value of the input/output queue depth (QD) is “1” after executing the first specific number of the input/output commands using the adaptive hybrid polling method, may return to the default mode, and may determine the adaptive hybrid polling method as the input/output completion checking method. When the average value of the input/output queue depth (QD) exceeds a first specific reference in a process of re-evaluating the input/output completion checking method, the input/output completion checking method determination unit 330 may determine that severe CPU contention persists after the sleep timer failure, may switch to the interrupt mode, and may determine the interrupt method as the input/output completion checking method. Otherwise, the input/output completion checking method determination unit 330 may maintain the CPU contention re-evaluation mode, and may determine to continue re-evaluating the input/output completion checking method using the adaptive hybrid polling method.

In addition, when the sleep timer failure does not occur, the input/output completion checking method determination unit 330 may check the number of active sleep timers, and may switch to the polling method or may maintain the adaptive hybrid polling method. Here, when the average value of the input/output queue depth (QD) is “1”, the input/output completion checking method determination unit 330 may determine that there is only one input/output request process assigned to the current CPU, and may switch to the polling mode to determine the input/output completion checking method as the polling method. When the average value of the input/output queue depth (QD) exceeds “1”, the input/output completion checking method determination unit 330 may maintain the adaptive hybrid polling method, may execute the first specific number of the input/output commands again, and thereafter may re-evaluate the input/output completion checking method.

In addition, the input/output completion checking method determination unit 330 may execute a second specific number of the input/output commands in the polling mode, and thereafter may switch to the default mode to return the input/output completion checking method to the adaptive hybrid polling method. Since the polling method exclusively uses the CPU until the input/output is completed, the sleep timer is not called, and the value of the input/output queue depth (QD) is always forced to be “1”. That is, in the polling mode, the number of the input/output request processes assigned to the CPU cannot be identified through the value of the input/output queue depth (QD), making the CPU contention un-measurable. Therefore, the input/output completion checking method determination unit 330 executes input/output commands for the second specific number in the polling method, thereafter unconditionally switches to the adaptive hybrid polling method, which is the default mode, and measures the CPU contention.

In addition, the input/output completion checking method determination unit 330 may execute a third specific number of the input/output commands using the interrupt method, and thereafter may switch to the CPU contention re-evaluation mode to return to the adaptive hybrid polling method. The input/output completion checking method determination unit 330 may measure the contention of the processor 210 in a process of performing the interrupt method, and may return to the adaptive hybrid polling method even before the third specific number of input/output commands are completed. However, when the input/output completion processing method is switched too frequently between the polling method and the interrupt method, there is a possibility that the I/O performance is degraded. Therefore, the input/output completion checking method determination unit 330 executes all of the third specific number of the input/output commands using the interrupt method, and thereafter switches to the adaptive hybrid polling method by returning to the CPU contention re-evaluation mode.

In one embodiment, the input/output completion checking method determination unit 330 may select the polling method, the adaptive hybrid polling method, or the interrupt method, based on the CPU contention. When a timer failure does not occur and the average value of the input/output queue depth (QD) is “1”, the input/output completion checking method determination unit 330 may check the input/output completion of the storage device through the polling method. When a timer failure occurs and the average value of the input/output queue depth (QD) exceeds the first specific reference, the input/output completion checking method determination unit 330 may check the input/output completion of the storage device through the interrupt method. When the above-described situations are excluded, the input/output completion checking method determination unit 330 may check the input/output completion of the storage device through the adaptive hybrid polling method. For example, when one input/output request process exclusively uses the CPU, the input/output completion checking method determination unit 330 may switch to the polling method to maximize I/O performance while using 100% of the CPU. In addition, when the polling method is used while two or more input/output request processes share the CPU, each process cannot exclusively use 100% of the CPU. Therefore, I/O performance may be seriously degraded. In this case, the input/output completion checking method determination unit 330 may avoid the degradation of the I/O performance of the polling method by using the adaptive hybrid polling method, which lowers the CPU usage through the sleep. In addition, when an excessive number of input/output request processes share the CPU, the timer delay may be worsened in the input/output completion checking method determination unit 330, thereby causing a timer failure in which oversleeping always occurs regardless of the length of the requested sleep duration from the adaptive hybrid polling. In this case, when the average value of the input/output queue depth (QD) exceeds the first specific reference immediately after the timer failure, the input/output completion checking method determination unit 330 may switch to the interrupt method to avoid the degradation of the I/O performance experienced by the adaptive hybrid polling method.

The input/output completion determination unit 350 may determine whether the input/output command is completed by performing an input/output checking procedure according to the input/output completion checking method. In one embodiment, when the system starts up, the input/output completion determination unit 350 may perform the input/output checking procedure using the adaptive hybrid polling method, which is set as the default mode of the input/output completion checking method, and may perform the input/output checking procedure by switching to or maintaining the input/output completion checking method of the storage device, which is selected by the input/output checking method determination unit 330 in a process of performing the adaptive hybrid polling method. In this manner, the input/output completion determination unit 350 may check whether the input/output is completed without degrading I/O performance.

The control unit 370 may control the overall operation of the input/output processing device 130, and may manage a control flow or a data flow between the input/output command generation unit 310, the input/output completion checking method determination unit 330, and the input/output completion determination unit 350.

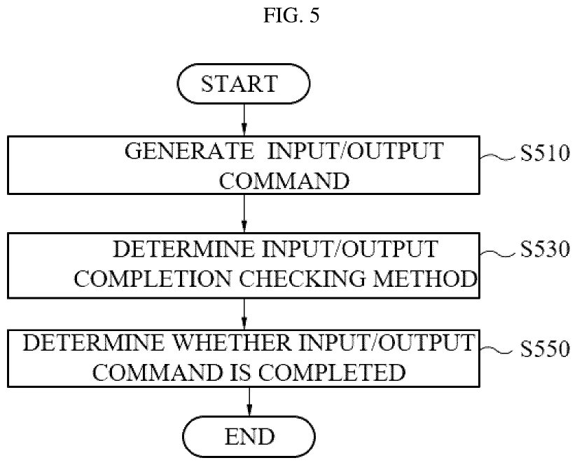

FIG. 5 is a flowchart for describing a method for processing input/output completion of the storage device according to the present disclosure.

Referring to FIG. 5, the input/output processing device 130 may generate the input/output command for the storage device 150 through the input/output command generation unit 310 (Step S510).

In addition, the input/output processing device 130 may provide the input/output request to the storage device 150, based on the input/output command through the input/output completion checking method determination unit 330, and may determine the input/output completion checking method of the storage device 150 (Step S530). The input/output completion checking method determination unit 330 may calculate the CPU contention through the adaptive hybrid polling method, and may select the polling method, the adaptive hybrid polling method, or the interrupt method, as the input/output completion checking method of the storage device 150, based on the calculated CPU contention.

In addition, the input/output processing device 130 may determine whether the input/output command is completed by performing the input/output checking procedure according to the input/output checking method through the input/output completion determination unit 350 (Step S550).

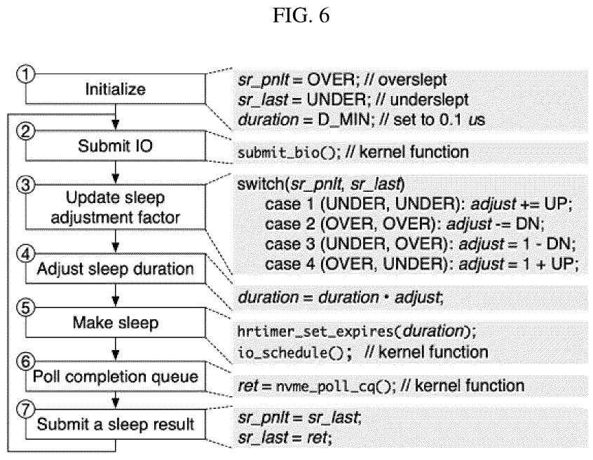

FIG. 6 is a view illustrating an example of an operation flow of the adaptive hybrid polling method according to the present disclosure.

The adaptive hybrid polling method proposes a prompt, accurate, and safe I/O latency tracking method (hereinafter referred to as PAS). The PAS may adjust the sleep time based on an order combination of the sleep results of the two most recent I/Os—classified as oversleeping and undersleeping—observed during a process of polling for I/O completion after the process has slept for the specified sleep time.

In the case of PAS operation in FIG. 6, various variables used for sleep duration adjustment are initialized to appropriate values, which may be referenced by the first generated input/output request (\textcircled{1}). Here, the initialization may be performed once when the operating system is configured to adopt the adaptive hybrid polling method as the default mode at system startup. The variables used for sleep duration adjustment may be defined as follows.

sr_pnlt represents a sleep result of the penultimate I/O, sr_last represents a sleep result of the last I/O, and duration represents the requested sleep duration managed by the PAS. During initialization, sr_pnlt and sr_last are set to oversleeping and undersleeping, respectively, and the duration can be set to an initial sleep duration (D_MIN). The initial sleep duration (D_MIN) may be set to 1 μs, which is small enough to prevent initial oversleeping until the PAS converges toward the lower envelope of the I/O time values.

Thereafter, once the PAS submits I/O (\textcircled{2}), the PAS adjusts the sleep adjustment factor (adjust) based on the sleep results (sr_pnlt, sr_last) of the two most recent I/Os (\textcircled{3}). The sleep adjustment factor may be updated based on the ordered combination (sr_pnlt, sr_last) of the sleep results from the two most recent I/Os. The order combination (sr_pnlt, sr_last) may represent one of four cases: (undersleeping, undersleeping), (oversleeping, oversleeping), (undersleeping, oversleeping), and (oversleeping, undersleeping). When the sleep results of the two most recent I/Os are the same, it is considered either case 1 or case 2, indicating an excessively underslept or overslept state. In response, the sleep adjustment factor may be increased by a predefined UP value (adjust+=UP), or decreased by a predefined DN value (adjust−=DN) to accelerate sleep compensation. Here, the values (UP, DN) may be predetermined. When the sleep results of the two most recent I/Os differ, as in case 3 or case 4, it may be determined that the sleep duration has reached the actual I/O latency and is just shifted in the opposite direction. Accordingly, the sleep adjustment factor is initialized to 1 and then either decreased by the DN value (adjust=1−DN) or increased by the UP value (adjust=1+UP).

Thereafter, the PAS adjusts the requested sleep duration (duration) using the updated sleep adjustment factor (\textcircled{4}), and then sleeps for the requested sleep duration (\textcircled{5}). Here, the PAS may set a minimum value for the requested sleep duration (for example, 1 μs or greater) to prevent excessive undersleeping.

Thereafter, the PAS wakes up from the sleep, moves the sleep result value sr_last to sr_pnlt, calls an OS kernel poll function, returns the sleep result of the current I/O, and stores the result in sr_last for reference in the subsequent sleep adjustment (\textcircled{6} and \textcircled{7}).

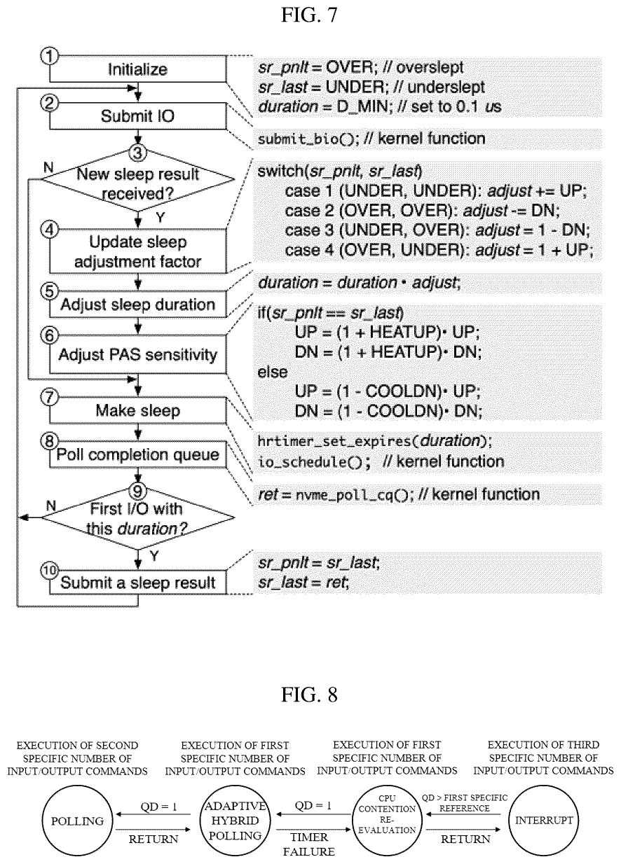

FIG. 7 is a view illustrating another embodiment of the operation flow of the adaptive hybrid polling method according to the present disclosure.

In FIG. 6, since the values of (UP, DN) are predetermined, the sensitivity of the PAS remains fixed. However, during intervals where the variation in the input/output latency of the storage device is smaller than in other intervals, the values of (UP, DN) may be reduced to enable closer latency tracking. Accordingly, the PAS may be extended to dynamically adjust its sensitivity based on the degree of change in the input/output latency.

In addition, in FIG. 6, the PAS does not consider situations where multiple processes run on a single CPU. If all processes attempt to update the requested sleep duration before the sleep result for the I/O in progress is obtained, the requested sleep duration may excessively increase or decrease. Moreover, when multiple processes successively submit sleep results, important sleep information—such as the (undersleeping, oversleeping) combination—may be immediately overwritten or lost in sr_last and sr_pnlt, leading to a side effect where critical result combinations are effectively purged. The extended PAS grants the right to submit the sleep result only to the first I/O process that uses the updated requested sleep duration. In addition, the aforementioned side effect may be prevented by granting the right to update the requested sleep duration to the first process executed immediately after a new sleep result is submitted.

In a case of an operation of the extended PAS in FIG. 7, after the I/O is submitted (\textcircled{2}), the extended PAS checks whether a new sleep result has been received (\textcircled{3}). If a new sleep result is received, the PAS adjusts the sleep adjustment factor based on the sleep results (sr_pnlt, sr_last) of the two most recent I/Os (\textcircled{4}), updates the requested sleep duration based on the adjusted sleep adjustment factor (\textcircled{5}), and then performs a sleep. Otherwise, the PAS performs a sleep based on the existing requested sleep duration (\textcircled{7}). The first process using the updated requested sleep duration has the authority to submit the sleep result by performing polling immediately after waking up from sleep (\textcircled{9}), and the first process checking the new sleep result may update the requested sleep duration based on the new sleep result.

The extended PAS adjusts I/O sensitivity using two newly introduced parameters, HEATUP and COOLDN (\textcircled{6}). In particular, when the sleep results (sr_pnlt, sr_last) of the two most recent I/Os are either (undersleeping, undersleeping) or (oversleeping, oversleeping), it is considered that the I/O tracking sensitivity is too low. In this case, the current values of (UP, DN) may be increased by a factor of (1+HEATUP), where HEATUP is set to a value greater than “0 (zero)”. Conversely, when the sleep results (sr_pnlt, sr_last) are different, such as (undersleeping, oversleeping) or (oversleeping, undersleeping), it is considered that the I/O tracking sensitivity is too high. The current values of (UP, DN) may then be decreased by a factor of (1−COOLDN), where COOLDN is set to a value greater than 0 and smaller than 1.

The PAS, as the adaptive hybrid polling method used in the present disclosure, has two fundamental limitations.

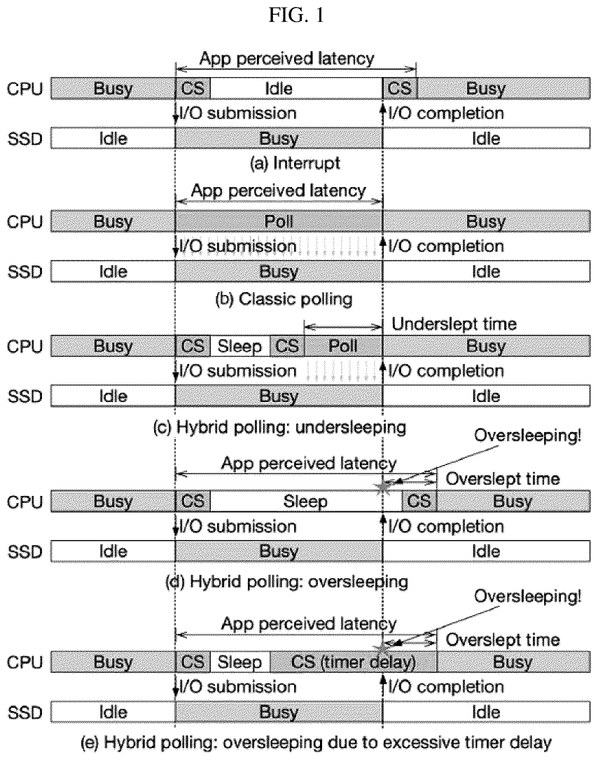

First, in the process of calling the timer function of the operating system for sleep, not only does a delay occur due to context switching, but there is also the issue of the working set of data being evicted from the cache. The former issue can be mitigated by setting the sleep duration short enough to induce undersleeping, as shown in FIG. 1(c). However, performance degradation caused by the latter issue cannot be hidden, even with a short sleep duration, because it results from a cache miss after the I/O request process is resumed. In such cases, the efficiency may be lower compared to the polling method.

Second, when too many processes share the CPU, the timer delay worsens, causing the hybrid polling method to fail to operate as intended and resulting in degraded I/O performance. The hybrid polling uses the timer function of the operating system to implement sleep, but the actual sleep duration—from the timer function call to its return—ends up being longer than the requested sleep duration, which is passed as an argument. This delay occurs because additional time is needed for the task scheduler to assign the CPU to the I/O request process after a timer interrupt occurs. The hybrid polling technique assumes that this timer delay—the difference between the actual sleep duration and the requested sleep duration—is sufficiently shorter than the I/O processing time of the storage device. However, when too many I/O request processes are waiting for CPU assignment, the timer delay of the I/O request process becomes more severe. In this case, even if the requested sleep duration of the hybrid polling is sufficiently short, the actual sleep duration increases, and by the time the CPU is assigned, the requested I/O may have already been completed, leading to oversleeping. In such situations, the performance may be degraded compared to the interrupt method.

In order to overcome the limitations of the PAS, the present disclosure proposes a dynamic switching technique for I/O completion checking (hereinafter, referred to as DPAS), which dynamically switches among three methods—the polling method, the adaptive hybrid polling (PAS) method, and the interrupt method—by observing the responsiveness of the kernel timer and the I/O queue depth (QD).

FIG. 8 is a view describing the process of switching the input/output completion checking method of the storage device according to the present disclosure.

Referring to FIG. 8, the apparatus for processing input/output completion 130 may dynamically switch the input/output completion checking method among four modes: the polling mode, the interrupt mode, and two variants of the PAS—namely the adaptive hybrid polling mode and the CPU contention re-evaluation mode. The adaptive hybrid polling mode is set as the default mode. The apparatus for processing input/output completion 130 is initially set to the adaptive hybrid polling mode at system startup and executes the first specific number of the input/output commands using the PAS method, which is the adaptive hybrid polling. During this process, it monitors for timer failures and calculates the average value of the input/output queue depth (QD). For example, the input/output processing device 130 may obtain an average QD value while performing 100 input/outputs using the PAS method. A QD value of “1” indicates that only one thread is currently executing I/O operations. In this case, the apparatus for processing input/output completion 130 switches to the polling mode, executes the second specific number of input/output commands using the polling method, and thereafter always returns to the adaptive hybrid polling mode. For example, the apparatus for processing input/output completion 130 may automatically return to the adaptive hybrid polling mode after executing 1,000 input/outputs using the polling method. The apparatus for processing input/output completion 130 performs the input/output using the PAS method in the adaptive hybrid polling mode. When at least one timer failure is detected, the apparatus for processing input/output completion 130 switches to the CPU contention re-evaluation mode and performs the input/output using the PAS method, which is the adaptive hybrid polling, to re-check the QD. If the QD value is greater than the first specific reference, the apparatus for processing input/output completion 130 switches to the interrupt mode, executes the third specific number of input/output commands using the interrupt method, and thereafter always returns to the CPU contention re-evaluation mode. For example, the input/output processing device 130 may automatically return to the CPU contention re-evaluation mode after performing 10,000 input/outputs using the interrupt method. The apparatus for processing input/output completion 130 returns to the adaptive hybrid polling mode only when the QD is determined to be “1”. The first specific reference, which serves as a threshold value for switching to the interrupt mode, may be set differently based on the characteristics of the storage device to optimize performance. For example, a value of 3 may be applied as the first specific reference for an Optane SSD based on 3D cross-point memory, while a value of 1 may be applied as the first specific reference for a NAND flash-based SSD.

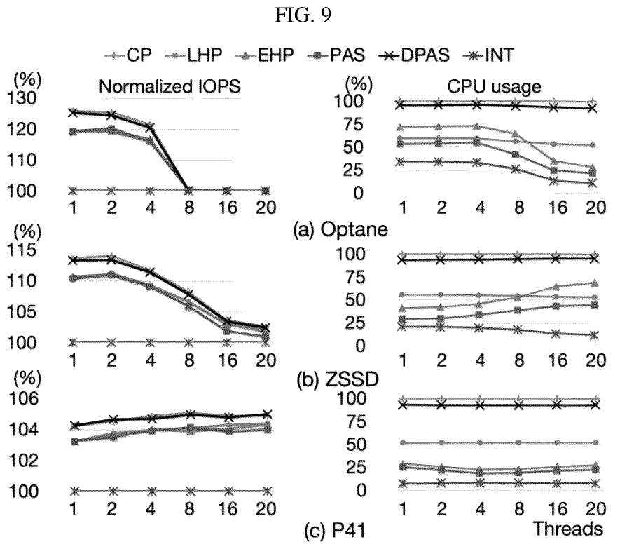

FIGS. 9 to 13 are graphs illustrating the results of performance analysis experiments conducted according to the present disclosure.

Referring to FIGS. 9 to 13, the apparatus for processing input/output completion 130 confirms that stable improvements in I/O performance were achieved across a variety of workloads, based on experiments conducted on various types of SSDs. Here, the I/O completion methods used for comparison include the interrupt (INT), the polling (CP), the Linux hybrid polling (LHP), the efficient hybrid polling (EHP), the PAS, and the DPAS proposed in the present disclosure.

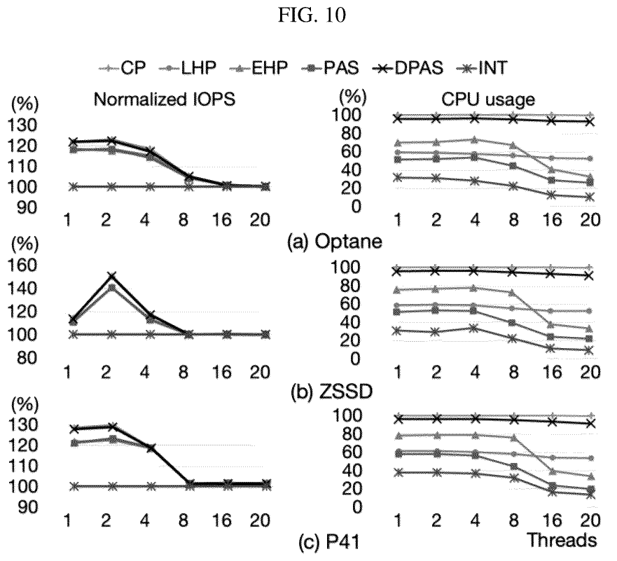

FIGS. 9 and 10 illustrate the I/O per seconds (IOPS) and CPU usage measured by performing 4 KB random read and random write I/O while executing an FIO benchmark program with 1 to 20 threads. Since one CPU core is assigned to each thread, the effective queue depth (QD) is maintained at 1. On the Optane SSD, the polling (CP) method achieves up to a 26% improvement in read IOPS and up to 23% improvement in write IOPS compared to the interrupt (INT) method. Although ZSSD and P41 achieve lower random read IOPS gains compared to Optane, they demonstrate better scalability due to higher internal parallelism. For writes, it is confirmed that ZSSD and P41 achieve write IOPS levels similar to Optane because, in each experiment, the FIO runs for only 10 seconds, allowing their internal DRAM buffers to absorb the write traffic. Until the I/O bandwidth becomes saturated as the number of threads increases, a significant IOPS gap is observed between the polling (CP) method and the hybrid polling methods (LHP, EHP, PAS) across all SSDs. LHP consistently consumes 50-60% of CPU resources, while EHP shows an ability to adjust CPU consumption as the number of threads increases and the SSD performance slows down. The PAS achieves the lowest CPU usage among the hybrid polling methods, but like the LHP and the EHP, the PAS still suffers from IOPS degradation compared to pure polling. In these setup, the DPAS, a dynamic mode switching technique, proposed in the present disclosure, achieves IOPS levels comparable to the CP while maintaining 92-95% of the CPU usage by dynamically switching between the polling mode and the adaptive hybrid-polling mode.

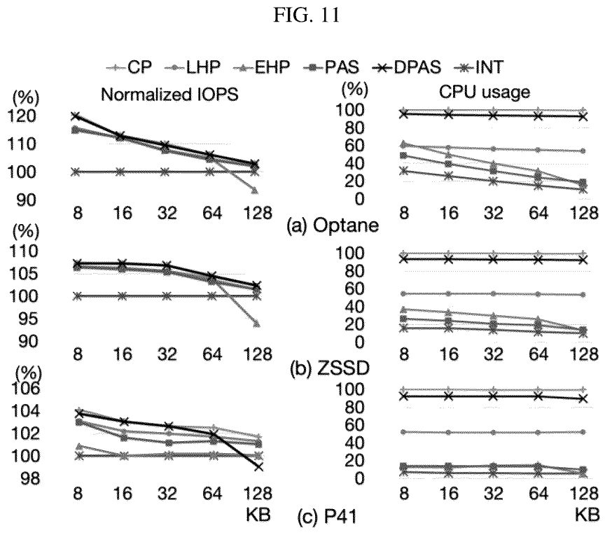

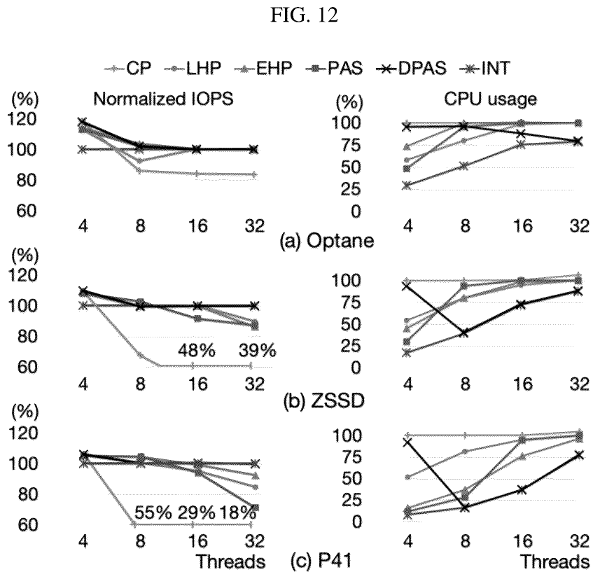

FIG. 11 illustrates that the polling method continues to deliver substantial performance advantages over the interrupt method, even as the I/O size increases. The LHP consistently consumes 50 to 60% of CPU usage regardless of the I/O size, while the EHP reduces CPU usage as the I/O size increases. However, the EHP fails to demonstrate significant performance improvements over the interrupt method for 128 KB I/O on Optane and ZSSD, and for 8 to 128 KB I/O on P41. For P41, the PAS shows slightly lower performance compared to the LHP in the 16 to 64 KB I/O range. The reason is that the lower envelope of I/O delays is more irregular on P41 compared to Optane and ZSSD, causing the PAS to be continuously exposed to slight oversleeping. The accumulated amount of oversleeping is sufficient to negate the relatively small IOPS gains that could otherwise be achieved on P41. FIG. 12 illustrates that the polling (CP) suffers from significant IOPS degradation with running 8 to 32 threads executing 4 KB random reads across four CPUs. On ZSSD and P41, the LHP, the EHP, and the PAS exhibit lower performance than the interrupt (INT) at 16 and 32 threads, as they wake up considerably later than the kernel timer intended. Among them, the PAS appears to be relatively more susceptible to this delayed wake-up phenomenon compared to the LHP and the EHP. Although timer failures also occur on Optane, the resulting IOPS drop for the hybrid polling method is not noticeable, since Optane is already operating near its saturation point. The graph of CPU usage in FIG. 12 shows that the DPAS adaptively switches modes in response to increasing CPU load. For 16 threads on Optane, the DPAS alternates between the CPU contention re-evaluation mode and the interrupt mode, effectively averaging the CPU usage across these modes. For 32 threads on Optane, as well as for 8 to 32 threads on ZSSD and P41, the DPAS handles most of I/O operations in the interrupt mode, which is also confirmed by the IOPS and the CPU usage measurements being almost identical to those of the pure interrupt mode.

To evaluate how DPAS dynamically adapts to fluctuating levels of CPU and I/O contention, an experiment was conducted using an I/O pulse generator that issues continuous random read I/Os based on three parameters: I/O size, target IOPS, and I/O pulse interval. In this experiment, both the YCSB workloads and the I/O generators were executed on CPU0 to CPU3, with each I/O generator issuing 128 KB random reads at 320 ms pulse interval to sustain 1,000 IOPS per generator. Since the I/O generators were activated intermittently, the baseline CPU contention remained low, while periodic CPU and I/O interference was introduced during their active phases. The graphs in the upper row of FIG. 13 show that the DPAS achieves average OPS (operations per second) improvements of 9%, 7%, and 5% over the INT on Optane, ZSSD, and P41, respectively. The PAS also delivers consistent performance gains, though slightly lower than the DPAS. In contrast, the polling (CP), the LHP, and the EHP often suffer significant performance degradation under the same conditions. The bar graphs in the bottom row of FIG. 13 illustrate how the DPAS dynamically adjusts its mode allocation depending on the device and workload. On Optane, the DPAS tends to remain in the CPU contention re-evaluation mode more frequently than on the other devices, reflecting its higher setting of the first specific reference value for switching to the interrupt mode.

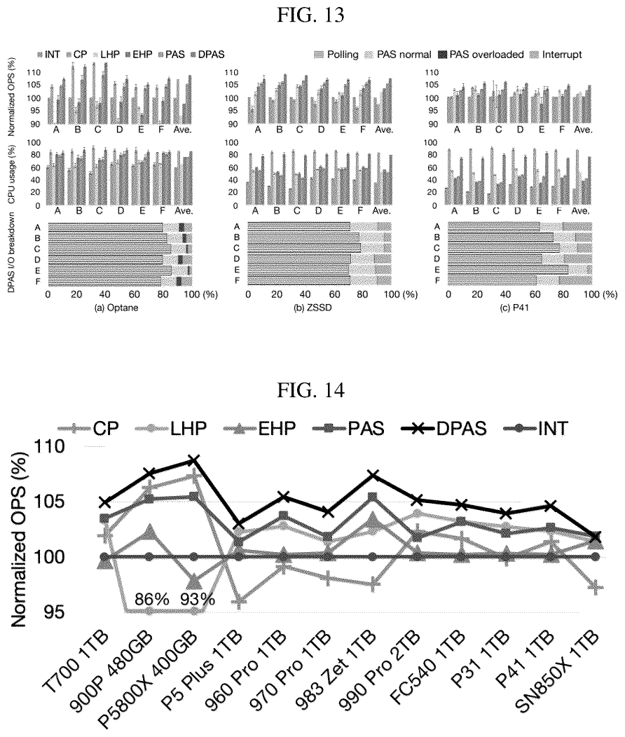

While the PAS does not require parameter tuning due to its dynamic sensitivity adjustment, the DPAS introduces a single tunable parameter, the first specific reference value for switching to the interrupt mode, set to 1 for NAND flash SSDs and 3 for 3D XPoint memory SSDs. To evaluate the performance of the DPAS without per-device tuning, it was tested on eight additional NAND flash SSDs and one additional 3D XPoint memory SSD, using the same experimental setup as in FIG. 13. FIG. 14 shows that the DPAS consistently outperforms the polling (CP), the LHP, the EHP, and the INT across most devices, except for the SN850X, where the DPAS performance slightly falls behind. The polling (CP), the LHP, and the EHP often fall behind the INT on several devices.

Although the present disclosure has been described above with reference to the preferred embodiments, it will be understood by those skilled in the art that the present disclosure may be corrected and modified in various ways within the scope not departing from the idea and the scope of the present disclosure in the appended claims.
100: system for processing input/output completion of storage device
110: user terminal
130: apparatus for processing input/output completion
150: storage device
210: processor
230 memory
250: user input/output unit
270: network input/output unit
310: input/output command generation unit
330: input/output completion checking method determination unit
350: input/output completion determination unit
370: control unit

What is claimed is:

1. An apparatus for processing input/output completion of a storage device, comprising:
an input/output command generation unit that generates an input/output command for the storage device;
an input/output completion checking method determination unit that issues an input/output request to the storage device based on the input/output command, and that determines an input/output completion checking method for the storage device; and
an input/output completion determination unit that performs an input/output checking procedure according to the input/output completion checking method, and that determines whether the input/output command has been completed.

2. The apparatus for processing input/output completion of a storage device of claim 1, wherein the input/output completion checking method determination unit determines the input/output completion checking method by selecting one from among a polling mode using a polling method, an adaptive hybrid polling mode using an adaptive hybrid polling method, a CPU contention re-evaluation mode using an adaptive hybrid polling method, and an interrupt mode using an interrupt method.

3. The apparatus for processing input/output completion of a storage device of claim 2, wherein the input/output completion checking method determination unit sets the adaptive hybrid polling mode as the default mode, calculates CPU contention using the adaptive hybrid polling method, and selects the mode based on the calculated CPU contention.

4. The apparatus for processing input/output completion of a storage device of claim 3, wherein the input/output completion checking method determination unit determines the CPU contention based on the number of active sleep timers running on the CPU and whether a timer failure occurs in a process of performing the adaptive hybrid polling method.

5. The apparatus for processing input/output completion of a storage device of claim 4, wherein the input/output completion checking method determination unit determines that a timer failure has occurred if a requested sleep duration is reduced to a predefined minimum sleep duration in a process of performing the adaptive hybrid polling method.

6. The apparatus for processing input/output completion of a storage device of claim 3, wherein, when the sleep timer failure does not occur, the input/output completion checking method determination unit executes a first specific number of the input/output commands by using the adaptive hybrid polling method, and thereafter checks the number of active sleep timers to switch to the polling mode or to maintain the adaptive hybrid polling mode.

7. The apparatus for processing input/output completion of a storage device of claim 6, wherein, when the number of active sleep timers identified through checking is “1”, the input/output completion checking method determination unit determines the polling method as the input/output completion checking method by switching to the polling mode.

8. The apparatus for processing input/output completion of a storage device of claim 7, wherein the input/output completion checking method determination unit executes a second specific number of the input/output commands by using the polling method, and thereafter, returns to the adaptive hybrid polling mode.

9. The apparatus for processing input/output completion of a storage device of claim 5, wherein, when the above sleep timer fails, the input/output completion checking method determination unit switches to the CPU contention re-evaluation mode, executes a first specific number of the input/output commands by using the adaptive hybrid polling method, and thereafter re-evaluates the input/output completion checking method.

10. The apparatus for processing input/output completion of a storage device of claim 9, wherein the input/output completion checking method determination unit checks the number of active sleep timers in a process of re-evaluating the input/output completion checking method, and determines whether to return to the adaptive hybrid polling mode, switch to interrupt mode, or maintain the CPU contention re-evaluation mode.

11. The apparatus for processing input/output completion of a storage device of claim 10, wherein, when the number of active sleep timers identified through checking is “1”, the input/output completion checking method determination unit returns to the adaptive hybrid polling mode.

12. The apparatus for processing input/output completion of a storage device of claim 10, wherein, when the number of active sleep timers identified through checking exceeds “1” and does not exceed a first specific reference, the input/output completion checking method determination unit maintains the CPU contention re-evaluation mode.

13. The apparatus for processing input/output completion of a storage device of claim 10, wherein, when the number of active sleep timers identified through checking exceeds a first specific reference, the input/output completion checking method determination unit selects the interrupt method as the input/output completion checking method by switching to the interrupt mode.

14. The apparatus for processing input/output completion of a storage device of claim 13, wherein the input/output completion checking method determination unit returns to the CPU contention re-evaluation mode after executing a third specific number of input/output commands using the interrupt method.

15. A method for processing input/output completion of a storage device, the method comprising:
an input/output command generation step of generating an input/output command for the storage device;
an input/output completion checking method determination step of providing an input/output request to the storage device based on the input/output command and determining an input/output completion checking method for the storage device; and
an input/output completion determination step of determining whether the input/output command is completed by performing an input/output checking procedure according to the input/output completion checking method.

16. The method for processing input/output completion of a storage device of claim 15, wherein, in the input/output completion checking method determination step, the input/output completion checking method is determined by selecting one from among a polling mode using a polling method, an adaptive hybrid polling mode using an adaptive hybrid polling method, a CPU contention re-evaluation mode using an adaptive hybrid polling method, and an interrupt mode using an interrupt method.

17. The method for processing input/output completion of a storage device of claim 16, wherein, in the input/output completion checking method determination step, the adaptive hybrid polling mode is set as the default mode, CPU contention is calculated through the adaptive hybrid polling method, and the mode is selected based on the calculated CPU contention.

18. The method for processing input/output completion of a storage device of claim 17, wherein, in the input/output completion checking method determination step, the CPU contention is determined based on the number of active sleep timers running on the CPU and whether a timer failure occurs in a process of performing the adaptive hybrid polling method.

19. The method for processing input/output completion of a storage device of claim 18, wherein, in the input/output completion checking method determination step, the occurrence of an event in which a requested sleep duration is reduced to a predefined minimum sleep duration in a process of performing the adaptive hybrid polling method is determined to be a timer failure.
